(19) United States
(12) Patent Application Publication
(10) Pub. No.: US 2017/0187072 A1
(43) Pub. Date: Jun. 29, 2017

(54) LITHIUM BATTERY ELECTROLYTE SOLUTION CONTAINING (2,2-DIFLUOROETHYL) ETHYL CARBONATE

(71) Applicant: Dow Global Technologies LLC, Midland, MI (US)

(72) Inventors: Lin Wang, Furlong, PA (US); Douglas A. Brune, Midland, MI (US); Ravi B. Shankar, Midland, MI (US); Matthew M. Yonkey, Sanford, MI (US)

(73) Assignee: Dow Global Technologies LLC, Midland, MI (US)

(21) Appl. No.: 15/308,597

(22) PCT Filed: May 15, 2015
(86) PCT No.: PCT/US2015/031162

§ 371 Date: Nov. 2, 2016

Related U.S. Application Data
(60) Provisional application No. 62/003,408, filed on May 27, 2014.

(51) Int. Cl. H01M 10/0569; H01M 4/505; H01M 4/525; H01M 10/052

(52) U.S. Cl. CPC H01M 10/0569; H01M 10/052; H01M 4/505; H01M 4/525; H01M 2300/0034; H01M 2300/0037; H01M 2004/028

(57) ABSTRACT

A battery electrolyte solution contains a lithium salt dissolved in a solvent phase comprising at least 10% by weight N of (2,2-difluoroethyl) ethyl carbonate. The solvent phase comprises optionally other solvent materials such as 4-fluoroethylene carbonate and other carbonate solvents. This battery electrolyte is highly stable even when used in batteries in which the cathode material has a high operating potential (such as 4.5V or more) relative to Li/Li⁺. Batteries containing this electrolyte solution therefore have excellent cycling stability.

The present invention relates to nonaqueous electrolyte solutions for lithium batteries.

Lithium batteries are widely used as primary and secondary batteries for vehicles and many types of electronic equipment. These batteries tend to have high energy and power densities and for that reason are favored in many applications.

In principle, one can increase the energy and power density of a battery by increasing its operating voltage. To this end, cathode materials have been developed which have operating potentials of 4.5V or more (vs. Li/Li⁺).

The electrolyte solution in a lithium battery is by necessity a nonaqueous type. The nonaqueous electrolyte solution is generally a high dielectric constant solution of a lithium salt in an organic solvent or a mixture of organic solvents.

One important attribute of the electrolyte solution is that it must form a stable solid electrolyte interface (SEI) layer on the anode during the initial battery charging cycles. The SEI layer functions to protect the anode from further unwanted reactions with the electrolyte solution and for that reason is critical to the performance of the battery. If no SEI layer forms, or if the SEI layer is not compact or stable, the battery will operate poorly if at all.

SEI formation involves complex electrochemical reactions of various components of the electrolyte solution. These reactions are not entirely understood and vary depending on the specific materials the electrolyte solution contains. Anode and cathode voltages also play a role. Because the reactions are so complex, it is very difficult to predict how well specific solvent candidates will form SEI layers. In fact, different solvents behave quite differently with respect to SEI formation, even when they are chemically quite similar. For example, carbonates are commonly used as electrolyte solvents. Among these, ethylene carbonate is a relatively good SEI former at some operating potentials, but the other carbonates are less so.

An additive sometimes is added to a carbonate-based electrolyte solution to enhance SEI formation. A range of compounds has been tried as SEI-promoting additives in carbonate-based solvent systems, with varying degrees of success. Their performance tends to depend greatly on the other materials present in the electrolyte solution. Many SEI-promoting additives work well in specific solvent systems and poorly in others.

For these reasons, it is very difficult to predict how well a specific electrolyte solution will form an effective SEI layer.

After the SEI layer is formed, it is important that the solution be as stable chemically, electrically and thermally as possible under the battery operating conditions. If the electrolyte solution degrades, the capacity of the battery will decrease over time. For so-called “secondary” batteries, which are designed to be recharged many times during their lives, this loss of capacity becomes a serious concern. It limits the performance of the battery during each successive discharge cycle and reduces the number of times the battery can be charged and discharged. The result is a significant reduction in battery life.

Thus, the battery electrolyte solution must be capable of first reacting at the anode to form a stable SEI layer, and thereafter reacting as little as possible so battery performance is maximized.

The problem of electrolyte stability becomes more pronounced as the operating potential of the cathode is increased, because fewer and fewer materials are electrochemically stable at the higher voltages. There is a relative wealth of battery electrolyte solvents that are useful when the operating potential is less than 3 volts. As newer cathode materials are developed, the operating potentials have increased to over 4 volts (relative to Li/Li⁺). At these potentials, many of the electrolyte solvents cannot be used because they degrade electrochemically. Even newer cathode materials, such as lithium-rich and layered types, have operating potentials of 4.5 volts or higher (vs. Li/Li⁺). At these potentials, it is very difficult to find battery electrolyte solutions that both form good SEI layers and have good cycling stability. Even ethylene carbonate is susceptible to degradation at these potentials.

This invention is in one aspect a battery electrolyte solution comprising at least one lithium salt dissolved in a nonaqueous solvent phase, wherein at least 10% by weight of the nonaqueous solvent phase is (2,2-difluoroethyl) ethyl carbonate.

This invention is also an electrical battery comprising an anode, a cathode, a separator disposed between the anode and cathode, and a nonaqueous battery electrolyte solution in contact with the anode and cathode, wherein the battery electrolyte solution comprises at least one lithium salt dissolved in a nonaqueous solvent in which the lithium salt is soluble, wherein at least 10% to the total weight of the nonaqueous solvent phase is (2,2-difluoroethyl) ethyl carbonate.

The electrolyte solutions of the invention have been found to form effective and stable SEI layers in lithium batteries. Lithium batteries in accordance with the invention have very good energy and power densities, and excellent rate performance. A significant advantage of the invention is in cycling performance. A battery of the invention retains a remarkably high proportion of its initial capacity after being cycled through many charge and discharge cycles.

The electrolyte solution of the invention has particular advantages in a battery in which at least one cathode material in the battery cathode has an operating voltage of at least 4.5V vs. Li/Li⁺. Thus a preferred battery of the invention has a cathode that contains such a cathode material.

Especially good results are obtained when the (2,2-difluoroethyl) ethyl carbonate is present as a mixture with one or more other solvents. One such mixture is a mixture of a) (2,2-difluoroethyl) ethyl carbonate and b) 4-fluoroethylene carbonate. Another such mixture is a mixture of a) (2,2-difluoroethyl) ethyl carbonate, b) 4-fluoroethylene carbonate and c) dimethyl carbonate and/or diethyl carbonate. A third mixture is a mixture of a) (2,2-difluoroethyl) ethyl carbonate, b) ethylene carbonate and c) diethyl carbonate.

The main components of the battery electrolyte solution are at least one lithium salt and a nonaqueous solvent phase that includes (2,2-difluoroethyl) ethyl carbonate. For purposes of this invention, the “solvent phase” includes all components of the battery electrolyte solution except the lithium salt(s). (2,2-Difluoroethyl) ethyl carbonate constitutes at least 10 weight-percent of the solvent phase.

(2,2-Difluoroethyl) ethyl carbonate has the structure:

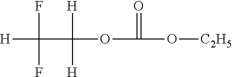

The lithium salt may be any that is suitable for battery use, including inorganic lithium salts such as LiAsF₆, LiPF₆, LiB(C₂O₄)₂, LiBF₄, LiBF₂C₂O₄, LiClO₄, LiBrO₄ and LiIO₄ and organic lithium salts such as LiB(C₆H₅)₄, LiCH₃SO₃, LiN(SO₂C₂F₅)₂ and LiCF₃SO₃. LiPF₆, LiClO₄, LiBF₄, LiAsF₆, LiCF₃SO₃ and LiN(SO₂CF₃)₂ are preferred types, and LiPF₆ is an especially preferred lithium salt.

The lithium salt is suitably present in a concentration of at least 0.5 moles/liter of electrolyte solution, preferably at least 0.75 moles/liter, up to 3 moles/liter, and more preferably up to 1.5 moles/liter, still more preferably up to 1.25 mole/liter, and even more preferably up to 1.1 moles/liter. Especially preferred amounts are 0.85 to 1.25 mole/liter and 0.85 to 1.1 moles/liter.

In some embodiments, (2,2-difluoroethyl) ethyl carbonate is the only component in the nonaqueous solvent phase.

In other embodiments, the nonaqueous solvent phase contains (2,2-difluoroethyl) ethyl carbonate in combination with one or more components. In such embodiments, (2,2-difluoroethyl) ethyl carbonate constitutes at least 10% by weight of the nonaqueous solvent phase.

The nonaqueous solvent phase may include one or more solvents for the lithium salt, in addition to the (2,2-difloroethyl) ethyl carbonate. Such additional solvents preferably are miscible with the (2,2-difluoroethyl) ethyl carbonate at the relative proportions that are present. Examples of such additional solvents include, for example, one or more linear alkyl carbonates, cyclic carbonates, cyclic esters, linear esters, cyclic ethers, alkyl ethers, nitriles, sulfones, sulfolanes, siloxanes and sultones. Mixtures of any two or more of the foregoing types can be used. Cyclic esters, linear alkyl carbonates, and cyclic carbonates are preferred types of nonaqueous solvents.

Suitable linear alkyl carbonates include dimethyl carbonate, diethyl carbonate, methyl ethyl carbonate and the like. Cyclic carbonates that are suitable include ethylene carbonate, propylene carbonate, butylene carbonate, 4-fluoroethylene carbonate, 3,4-difluoroethylene carbonate and the like. Suitable cyclic esters include, for example, γ-butyrolactone and γ-valerolactone. Cyclic ethers include tetrahydrofuran, 2-methyltetrahydrofuran, tetrahydropyran and the like. Alkyl ethers include dimethoxyethane, diethoxyethane and the like. Nitriles include mononitriles, such as acetonitrile and propionitrile, dinitriles such as glutaronitrile, and their derivatives. Sulfones include symmetric sulfones such as dimethyl sulfone, diethyl sulfone and the like, asymmetric sulfones such as ethyl methyl sulfone, propyl methyl sulfone and the like, and their derivatives. Sulfolanes include tetramethylene sulfolane and the like.

The nonaqueous solvent phase in some embodiments is a mixture that includes (2,2-difluoroethyl) ethyl carbonate and at least one other carbonate solvent. The carbonate solvent in such a mixture may be, for example, one or more of ethylene carbonate, propylene carbonate, 4-fluoroethylene carbonate, 3,4-difluoroethylene carbonate, dimethyl carbonate, diethyl carbonate and ethyl methyl carbonate. (2,2-difluoroethyl) ethyl carbonate constitutes at least 10 weight-%, preferably at least 20 weight-% and more preferably at least 30 weight-% of such a nonaqueous solvent phase. (2,2-Difluoroethyl) ethyl carbonate may constitute up to 99 weight-%, preferably up to 75 weight-%, of such a nonaqueous solvent phase. The mixture of (2,2-difluoroethyl) ethyl carbonate and other carbonate solvent(s) may constitute 50 to 100 weight-%, 80 to 100 weight-%, 90 to 100 weight-% or 98 to 100% of the nonaqueous solvent phase. The mixture of (2,2-difluoroethyl) ethyl carbonate and other carbonate solvent(s) may constitute the entire nonaqueous solvent phase.

An example of such a nonaqueous solvent phase includes a mixture of a) 50 to 94 weight-% (2,2-difluoroethyl) ethyl carbonate, b) 5 to 50 weight-% 4-fluoroethylene carbonate and c) 1 to 50 weight-% of dimethyl carbonate and/or diethyl carbonate, based on the combined weight of these components. In some embodiments, this nonaqueous solvent phase contains 50 to 75 weight-% (2,2-difluoroethyl) ethyl carbonate, 5 to 15 weight-% 4-fluoroethylene carbonate and 20 to 35 weight-% of dimethyl carbonate and/or diethyl carbonate, based on the combined weight of these components. In other embodiments, this nonaqueous solvent phase contains 50 to 90 weight-% (2,2-difluoroethyl) ethyl carbonate, 5 to 30 weight-% 4-fluoroethylene carbonate and 5 to 40 weight-% of dimethyl carbonate and/or diethyl carbonate, based on the combined weight of these components. The mixture of components of a), b) and c) as described in this paragraph may constitute, for example, 50 to 100 weight-%, 80 to 100 weight-%, 90 to 100 weight-%, 95 to 100 weight-%, or 98 to 100 weight-% of the nonaqueous solvent phase. The mixture of components of a), b) and c) as described in this paragraph may constitute the entire nonaqueous solvent phase.

Another example of such a nonaqueous solvent phase includes a mixture of a) 50 to 94 weight-% (2,2-difluoroethyl) ethyl carbonate, b) 5 to 50 weight-% ethylene carbonate and c) 1 to 50 weight-% of diethyl carbonate, based on the combined weight of these components. In some embodiments, this nonaqueous solvent phase contains 50 to 75 weight-% (2,2-difluoroethyl) ethyl carbonate, 5 to 15 weight-% ethylene carbonate and 20 to 35 weight-% of diethyl carbonate, based on the combined weight of these components. The mixture of components of a), b) and c) as described in this paragraph may constitute, for example, 50 to 100 weight-%, 80 to 100 weight-%, 90 to 100 weight-%, 95 to 100 weight-%, or 99 to 100 weight-% of the nonaqueous solvent phase. The mixture of components of a), b) and c) as described in this paragraph may constitute the entire nonaqueous solvent phase.

Another example of a nonaqueous solvent phase includes a) (2,2-difluoroethyl) ethyl carbonate and b) 4-fluoroethylene carbonate. The proportions of these components may be, for example, 50 to 98 weight-%, preferably 70 to 95 weight-%, more preferably 75 to 95 weight-% and still more preferably 75 to 85 weight-% (2,2-difluoroethyl) ethyl carbonate, and 2 to 50 weight-%, preferably, preferably 5 to 30 weight-%, more preferably 5 to 25 weight-% and still more preferably 15 to 25 weight-% 4-fluoroethylene carbonate. These percentages are based on combined weight of (2,2-difluoroethyl) ethyl carbonate and 4-fluoroethylene carbonate. In these embodiments, (2,2-difluoroethyl) ethyl carbonate and 4-fluoroethylene carbonate together may constitute, for example, 50 to 100 weight-%, 80 to 100 weight-%, 90 to 100 weight-%, 95 to 100 weight-%, or 99 to 100 weight-% of the nonaqueous solvent phase. The (2,2-difluoroethyl) ethyl carbonate and 4-fluoroethylene carbonate together may constitute the entire nonaqueous solvent phase.

Various other additives may be present in the battery electrolyte solution, in addition to the components already mentioned. These other additives, for purposes of this invention, are considered as part of the nonaqueous solvent phase. These may include, for example, additives which promote the formation of a solid electrolyte interface at the surface of a graphite electrode; various cathode protection agents; lithium salt stabilizers; lithium deposition improving agents; ionic solvation enhancers; corrosion inhibitors; wetting agents; flame retardants; and viscosity reducing agents. Many additives of these types are described by Zhang in “A review on electrolyte additives for lithium-ion batteries”, J. Power Sources 162 (2006) 1379-1394.

Agents which promote solid electrolyte interface (SEI) formation include various polymerizable ethylenically unsaturated compounds, various sulfur compounds, as well as other materials. Ethylenically unsaturated compounds include carbonate compounds that have aliphatic carbon-carbon unsaturation such as vinylidine carbonate, vinyl ethyl carbonate, allyl ethyl carbonate and the like. Sulfur compounds include sultones, i.e., cyclic sulfonate esters of hydroxyl sulfonic acids. An example of a suitable sultone compound is 1,3-propane sultone. Suitable cathode protection agents include materials such as N,N-diethylaminotrimethylsilane and LiB(C₂O₄)₂. Lithium salt stabilizers include LiF, tris(2,2,2-trifluoroethyl)phosphite, 1-methyl-2-pyrrolidinone, fluorinated carbamate and hexamethylphosphoramide. Examples of lithium deposition improving agents include sulfur dioxide, polysulfides, carbon dioxide, surfactants such as tetraalkylammonium chlorides, lithium and tetraethylammonium salts of perfluorooctanesulfonate, various perfluoropolyethers and the like. Crown ethers can be suitable ionic solvation enhancers, as are various borate, boron and borole compounds. LiB(C₂O₄)₂ and LiF₂C₂O4 are examples of aluminum corrosion inhibitors. Cyclohexane, trialkyl phosphates and certain carboxylic acid esters are useful as wetting agents and viscosity reducers. Some materials, such as LiB(C₂O₄)₂, may perform multiple functions in the electrolyte solution.

The various other additives may together constitute up to 50%, up to 20%, preferably up to 10% of the total weight of the nonaqueous solvent phase.

An advantage of this invention is that SEI-promoting additives are not necessary and can be omitted from the formulation or, if used, used in only small amounts. Thus, in some embodiments, the nonaqueous solvent phase contains no more than 5 weight-percent, not more than 1 weight-percent or no more than 0.25 weight percent of polymerizable ethylenically unsaturated compounds and sulfur-containing compounds.

The battery electrolyte solution is conveniently prepared by dissolving or dispersing the lithium salt, into one or more of the components of the nonaqueous solvent phase. If the nonaqueous solvent phase is a mixture of materials, the lithium salt can be dissolved into the mixture, any component thereof, or any subcombination of those components. The order of mixing is in general not critical.

By “nonaqueous”, it is meant the solvent phase contains less than 500 ppm of water (on a weight basis). A water content of 50 ppm or less is preferred and a more preferred water content is 30 ppm or less. The battery electrolyte solution as a whole also is nonaqueous, and also contains water (if at all) in similar amounts. The various components of the battery electrolyte solution can be individually dried if necessary before forming the battery electrolyte solution, and/or the formulated battery electrolyte solution can be dried to remove residual water. The drying method selected should not degrade or decompose the various components of the battery electrolyte solution, nor promote undesired reactions between them. Thermal methods can be used, as can drying agents such as molecular sieves.

A battery containing the battery electrolyte solution of the invention can be of any useful construction. A typical battery construction includes an anode and cathode, with a separator and the electrolyte solution interposed between the anode and cathode so that ions can migrate through the electrolyte solution between the anode and the cathode. The assembly is generally packaged into a case. The shape of the battery is not limited. The battery may be a cylindrical type containing spirally-wound sheet electrodes and separators. The battery may be a cylindrical type having an inside-out structure that includes a combination of pellet electrodes and a separator. The battery may be a plate type containing electrodes and a separator that have been superimposed.

Suitable anode materials include, for example, carbonaceous materials such as natural or artificial graphite, carbonized pitch, carbon fibers, graphitized mesophase microspheres, furnace black, acetylene black and various other graphitized materials. The carbonaceous materials may be bound together using a binder such as a poly(vinylidene fluoride), polytetrafluoroethylene, a styrene-butadiene copolymer, an isoprene rubber, a poly(vinyl acetate), a poly(ethyl methacrylate), polyethylene or nitrocellulose. Suitable carbonaceous anodes and methods for constructing same are described, for example, in U. S. Pat. No. 7,169,511.

Other suitable anode materials include lithium metal, silicon, tin, lithium alloys and other lithium compounds such as a lithium titanate anode.

Suitable cathode materials include inorganic compounds such as transition metal oxides, transition metal/lithium composite oxides, lithium/transition metal composite phosphates, transition metal sulfides, metal oxides, and transition metal silicates. Examples of transition metal oxides include MnO, V₂O₅, V₆O₁₃ and TiO₂. Transition metal/lithium composite oxides include lithium/cobalt composite oxides whose basic composition is approximately LiCoO₂, lithium/nickel composite oxides whose basic composition is approximately LiNiO₂, and lithium/manganese composite oxides whose basic composition is approximately LiMn₂O₄ or LiMnO₂. In each of these cases, part of the cobalt, nickel or manganese can be replaced with one or two metals such as Al, Ti, V, Cr, Fe, Co, Ni, Cu, Zn, Mg, Ga or Zr. Lithium/transition metal composite phosphates include lithium iron phosphate, lithium manganese phosphate, lithium cobalt phosphate, lithium iron manganese phosphate and the like.

In preferred embodiments, the anode and cathode material are selected together to provide the battery with an operating voltage of at least 4.5V. A preferred cathode material is a lithium nickel manganese cobalt electrode material, in particular those types as are sometimes referred to as a lithium-rich metal oxide or lithium-rich layered oxide (each being identified herein by the acronym LRMO). These materials generally display a layered structure with monoclinic and rhombohedral domains. They may have initial specific discharge capacities of 270 mAh/g or more when charged to a voltage of about 4.6 volts vs. Li/Li⁺.

Suitable LRMO cathode materials include those represented by the formula LiₓM_{y}O₂, in which 1<x<2, y is 1 and M is any metal that has an oxidation state from 2 to 4. Preferably, M is a combination of metals, wherein one of the metals is Ni. In a preferred embodiment, M is a mixture of Ni and Mn or of Ni, Mn and Co. In such cases, the LMRO cathode material may be one represented by the formula LiₓNi_{1-a-b}MnₐCo_{b}O₂, wherein such that 0.2≦a≦0.9 and 0.1≦b≦0.8. More preferably, 0.2≦a≦0.5, 0.1≦b≦0.5 and a+b≦0.8. x is preferably 1.005 to 1.2, more preferably 1.01 to 1.15.

The LRMO may also contain small amounts of anionic dopants that improve one or more properties, with an example being fluorine.

Suitable LRMO cathode materials include those described in U.S. Pat. Nos. 5,993,998, 6,677,082, 6,680,143, 7,205,072, 7,435,402 and 8,187,752; Japanese Unexamined Pat. No. 11307094A; EP Pat. Appl. No. 1193782; Chem. Mater. 23 (2011) 3614-3621; and J. Electrochem. Soc., 145:12, December 1998 (4160-4168).

The LRMO may be coated with, for example, a non-ionic conductive solid such as, for example, lithium phosphate, lithium sulfide, lithium lanthanum titanate as described in US 2011-0081578, and/or with a coating such as Al₂O₃, La₂O₃ or AlF₃. It may have an etched surface containing stabilizing ammonium phosphorus, titanium, silicon, zirconium, aluminum, boron and/or fluorine atoms as described in US 2007-0281212.

The LRMO cathode material in some embodiments displays a specific capacity of at least 250 mAh/g, when discharged at a C rate of 0.05 from 4.6 volts to 2 volts.

The battery electrodes are each generally in electrical contact with or formed onto a current collector. A suitable current collector for the anode is made of a metal or metal alloy such as copper, a copper alloy, nickel, a nickel alloy, stainless steel and the like. Suitable current collectors for the cathode include those made of aluminum, titanium, tantalum, alloys of two or more of these and the like.

The separator is interposed between the anode and cathode to prevent the anode and cathode from coming into contact with each other and short-circuiting. The separator is conveniently constructed from a nonconductive material. It should not be reactive with or soluble in the electrolyte solution or any of the components of the electrolyte solution under operating conditions. Polymeric separators are generally suitable. Examples of suitable polymers for forming the separator include polyethylene, polypropylene, polybutene-1, poly-3-methylpentene, ethylene-propylene copolymers, polytetrafluoroethylene, polystyrene, polymethylmethacrylate, polydimethylsiloxane, polyethersulfones and the like.

The electrolyte solution must be able to permeate through the separator. For this reason, the separator is generally porous, being in the form of a porous sheet, nonwoven or woven fabric or the like. The porosity of the separator is generally 20% or higher, up to as high as 90% of the surface area. A preferred porosity is from 30 to 75% of the surface area. The pores are generally no larger than 0.5 microns, and are preferably up to 0.05 microns, in their longest dimension. The separator is typically at least one micron thick, and may be up to 50 microns thick. A preferred thickness is from 5 to 30 microns.

The amount of electrolyte solution may be, for example, up to 20 g/A·h (grams per ampere-hour of cathode capacity) or more, but the invention is of particular benefit in low electrolyte batteries in which the amount of electrolyte is up to 10 g/A·h of cathode capacity. In some embodiments, the battery contains 3 to 7, 3 to 6 or 3 to 5 g of battery electrolyte solution per A·h of cathode capacity. Cathode capacity is determined by measuring the specific capacity of the cathode material in a half-cell against a lithium counter-electrode, and multiplying by the weight of cathode material in the cathode.

The battery is preferably a secondary (rechargeable) lithium battery. In such a battery, the discharge reaction includes a dissolution or delithiation of lithium ions from the anode into the electrolyte solution and concurrent incorporation of lithium ions into the cathode. The charging reaction, conversely, includes an incorporation of lithium ions into the anode from the electrolyte solution. Upon charging, lithium ions are reduced on the anode side, at the same time, lithium ions in the cathode material dissolve into the electrolyte solution.

The battery of the invention can be used in industrial applications such as electric vehicles, hybrid electric vehicles, plug-in hybrid electric vehicles, aerospace, e-bikes, etc. The battery of the invention is also useful for operating a large number of electrical and electronic devices, such as computers, cameras, video cameras, cell phones, PDAs, MP3 and other music players, televisions, toys, video game players, household appliances, power tools, medical devices such as pacemakers and defibrillators, among many others.

The following examples are provided to illustrate the invention, but are not intended to limit the scope thereof. All parts and percentages are by weight unless otherwise indicated.

General method for preparation of button cells: An aluminum doped/AlF₃ coated lithium rich nickel manganese cobalt oxide LRMO cathode material is mixed with polyvinylidene difluoride, vapor grown carbon fiber and conductive carbon black in a 90:5:2.5:2.5 weight ratio. The mixture is then slurried into N-methyl pyrrolidone. The slurry is coated onto 19 μm etched aluminum current collector and dried. The dried coating weight is about 5.5 mg/cm². The electrodes are pressed to a thickness of about 30 μm, to form a cathode having a capacity of about 2.4 mAh (based on a nominal specific capacity of 250 mAh/g of the cathode material).

Button cells are produced using these cathodes and synthetic graphic anodes. A dried cathode is laid onto a bottom casing. A separator is laid on top of the cathode and secured by an O-ring. 10 μL of electrolyte solution is dispensed onto the separator. Anode, spacer and top casing are then added in sequence to form the button cells.

General Battery Cycling Method: Button cells are rested for 24 hours after assembly to allow the electrolyte to fully wet out the separator. The first charge discharge cycle is performed at 0.05 C (1 C being the charging rate necessary to charge the cells to nominal capacity in one hour), followed by a 0.1 C charge/discharge cycle to check low rate capacity. Initial capacity is then measured using 1 C/1 C charge/discharge rates. The cells are thereafter cycled at 1/1 C charge/discharge rates for at least 70 cycles with a 0.1 C charge/discharge cycle every 25 cycles to check internal impedance.

### EXAMPLES 1-6

Battery electrolyte solution Examples 1-6 have the following formulations.

TABLE 1

| | Solvent, Weight-% based on Total Solvents | | | | |
|---|---|---|---|---|---|
| Designation | DFEEC¹ | FEC² | EMC⁴ | DMC⁵ | Salt |
| Ex. 1 | 90 | 10 | 0 | 0 | 1.2M LiPF₆ |
| Ex. 2 | 80 | 20 | 0 | 0 | 1.2M LiPF₆ |
| Ex. 3 | 70 | 30 | 0 | 0 | 1.2M LiPF₆ |
| Ex. 4 | 90 | 10 | 0 | 0 | 1.0M LiPF₆ |
| Ex. 5 | 60 | 10 | 30 | 0 | 1.2M LiPF₆ |
| Ex. 6 | 60 | 30 | 0 | 10 | 1.2M LiPF₆ |

¹DFEEC is 2,2-difluoroethyl ethyl carbonate.
²FEC is 4-fluoroethylene carbonate.
³DEC is diethyl carbonate.
³EMC is ethyl methyl carbonate.
⁴DMC is dimethyl carbonate.

Batteries containing each of these electrolyte solutions are evaluated for cycling stability. Results are as indicated in Table 2.

TABLE 2

| | | 1 C Specific Capacity, mAh/g | | |
|---|---|---|---|---|
| Designation | Solvent | Initial | 70^{th} cycle | % Loss |
| Ex. 1 | 90DFEEC/10FEC | 210 | 182 | 13.3 |
| Ex. 2 | 80DFEEC/20FEC | 213 | 186 | 12.7 |
| Ex. 3 | 70DFEEC/30FEC | 200 | 179 | 10.5 |
| Ex. 4 | 90DFEEC/10FEC | 213 | 183 | 14.1 |
| | (1.0M LiPF₆) | | | |
| Ex. 5 | 60DFEEC/10FEC/30EMC | 213 | 178 | 16.4 |
| Ex. 6 | 30DFEEC/10FEC/60DMC | 219 | 190 | 13.2 |

Examples 1 and 4 show that similar results are obtained at a somewhat different lithium salt loading. In Examples 2 and 3, the proportion of DFEEC is reduced somewhat compared to Example 1. This results in better specific capacity retention.

Example 5 represents a modification of Example 1, in which some of the DFEEC is replaced with ethyl methyl carbonate. Good initial capacity is obtained (indicating the formation of a good SEI layer), but capacity retention is worse. Example 6 shows the effect of replacing some of the DFEEC with dimethyl carbonate instead of the ethyl methyl carbonate of Example 5. This combination is clearly the best performer. Examples 1, 5 and 6 together (and in particular Examples 5 and 6) show the unpredictability of solvent performance. Replacing part of DFEEC with ethyl methyl carbonate (Ex. 5) results in a significant deterioration in capacity retention, whereas replacing DFEEC with dimethyl carbonate (Ex. 6) instead of the chemically similar ethyl methyl carbonate leads to very high initial capacity and very good capacity retention. Example 6 is considered the best performer among this set of experiments.

### EXAMPLES 7-10

Battery electrolyte solution Examples 7-10 have the following formulations.

TABLE 3

| | Solvent, Weight-% based on Total Solvents | | | | |
|---|---|---|---|---|---|
| Designation | DFEEC¹ | FEC² | DEC³ | EC⁴ | Salt |
| Ex. 7 | 90 | 0 | 0 | 10 | 1.2M LiPF₆ |
| Ex. 8 | 90 | 10 | 0 | 0 | 1.2M LiPF₆ |
| Ex. 9 | 60 | 0 | 30 | 10 | 1.2M LiPF₆ |
| Ex. 10 | 30 | 0 | 60 | 10 | 1.2M LiPF₆ |

¹DFEEC is 2,2-difluoroethyl ethyl carbonate.
²FEC is 4-fluoroethylene carbonate.
³DEC is diethyl carbonate.
⁴EC is ethylene carbonate.

Batteries containing each of these electrolyte solutions are evaluated for cycling stability. Results are as indicated in Table 4.

TABLE 4

| | | 1 C Specific Capacity, mAh/g | | |
|---|---|---|---|---|
| Designation | Solvent | Initial | 70^{th} cycle | % Loss |
| Ex. 7 | 90DFEEC/10EC | 216 | 178 | 17.6 |
| Ex. 8 | 90DFEEC/10FEC | 217 | 188 | 13.4 |
| Ex. 9 | 60DFEEC/10EC/30DEC | 207 | 181 | 12.6 |
| Ex. 10 | 30DFEEC/10EC/60DEC | 218 | 178 | 19.2 |

This data shows the unpredictability in the performance of battery electrolyte solutions, and their sensitivity to what might appear to be only minor formulation changes. Substitution of FEC for an equal amount of EC (Ex. 8 vs. Ex. 7) results in approximately equal initial capacity but a large improvement in cycling performance. Examples 9 and 10 show the effect of replacing a portion of DFEEC with diethyl carbonate; a significant increase in cycling stability is seen in Example 9, which compensates for a small loss in initial capacity is compensated so that after 70 cycles the remaining capacity of Example 9 is better than Example 7. At higher numbers of cycles, the specific capacity of Example 9 is expected to exceed Example 7. When more of the DFEEC is replaced with diethyl carbonate, as in Example 10, capacity retention suffers.

1. A battery electrolyte solution comprising at least one lithium salt dissolved in a nonaqueous solvent phase, wherein at least 10% by weight of the nonaqueous solvent phase is (2,2-difluoroethyl) ethyl carbonate, which battery electrolyte solution contains no more than 1 weight percent of polymerizable ethylenically unsaturated compounds and sulfur-containing compounds.

2. The battery electrolyte solution of claim 1 wherein the nonaqueous solvent phase further contains one or more of a linear alkyl carbonate, a cyclic carbonate, a cyclic ester, a linear ester, a cyclic ether, an alkyl ether, a nitrile, a sulfone, a sulfolane, a siloxane and a sultone.

3. The battery electrolyte solution of claim 2 wherein the nonaqueous solvent phase further contains at least one other carbonate solvent.

4. The battery electrolyte solution of claim 2 wherein the nonaqueous solvent phase includes one or more of ethylene carbonate, propylene carbonate, 4-fluoroethylene carbonate, 3,4-difluoroethylene carbonate, dimethyl carbonate, diethyl carbonate and ethyl methyl carbonate.

5. The battery electrolyte solution of claim 1 wherein the nonaqueous solvent phase includes a mixture of a) 50 to 94 weight-% (2,2-difluoroethyl) ethyl carbonate, b) 5 to 50 weight-% 4-fluoroethylene carbonate and c) 1 to 50 weight-% of dimethyl carbonate and/or diethyl carbonate, based on the combined weight of a), b) and c).

6. The battery electrolyte solution of claim 1 wherein the nonaqueous solvent phase contains 50 to 90 weight-% (2,2-difluoroethyl) ethyl carbonate, 5 to 30 weight-% 4-fluoroethylene carbonate and 5 to 40 weight-% of dimethyl carbonate and/or diethyl carbonate, based on the combined weight of these components.

7. The battery electrolyte solution of claim 6 wherein components a), b) and c) constitute 95 to 100 weight-% of the nonaqueous solvent phase.

8. The battery electrolyte solution of claim 1 wherein the nonaqueous solvent phase includes a mixture of a) 50 to 94 weight-% (2,2-difluoroethyl) ethyl carbonate, b) 5 to 50 weight-% ethylene carbonate and c) 1 to 50 weight-% of diethyl carbonate, based on the combined weight of a), b) and c).

9. The battery electrolyte solution of claim 1 wherein the nonaqueous solvent phase contains a) 50 to 75 weight-% (2,2-difluoroethyl) ethyl carbonate, b) 5 to 15 weight-% ethylene carbonate and c) 20 to 35 weight-% of diethyl carbonate, based on the combined weight of a), b) and c).

10. The battery electrolyte solution of claim 9 wherein components a), b) and c) constitute 95-100 weight-% of the nonaqueous solvent phase.

11. The battery electrolyte solution of claim 1 wherein the nonaqueous solvent phase includes a) 50-99 weight percent (2,2-difluoroethyl) ethyl carbonate and b) 1 to 50 weight percent 4-fluoroethylene carbonate, based on the combined weight of a) and b).

12. The battery electrolyte solution of claim 1 wherein the nonaqueous solvent phase includes a) 75-95 weight percent (2,2-difluoroethyl) ethyl carbonate and b) 5-25 weight percent 4-fluoroethylene carbonate, based on the combined weight of a) and b).

13. The battery electrolyte solution of claim 1 wherein the nonaqueous solvent phase includes a) 75-85 weight percent (2,2-difluoroethyl) ethyl carbonate and b) 15-25 weight percent 4-fluoroethylene carbonate, based on the combined weight of a) and b).

14. The battery electrolyte solution of claim 13 wherein components a) and b) constitute 95 to 100 weight-% of the nonaqueous solvent phase.

15. The battery electrolyte solution of claim 1 which contain 0.85 to 1 M of the lithium salt.

16. (canceled)

17. A secondary lithium electrical battery having an operating potential of at least 4.5V vs. Li/Li⁺comprising an anode, a lithium rich metal oxide cathode, a separator disposed between the anode and cathode, and the battery electrolyte solution of claim 1 in contact with the anode and cathode.

18.-20. (canceled)

21. The electrical battery of claim 17 wherein the lithium rich metal oxide is represented by the formula LiₓM_{y}O₂, in which 1<x<2, y is 1 and M is a metal that has an oxidation state from 2 to 4.

22. The electrical battery of claim 21 wherein the lithium rich metal oxide is represented by the formula LiₓNi_{1-a-b}MnₐCo_{b}O₂, wherein 0.2≦a≦0.9 and 0.1≦b≦0.8.

23. The electrical battery of claim 22 wherein x is 1.01 to 1.15.

24. The electrical battery of claim 17 wherein the amount of battery electrolyte solution is 3 to 6 g/A·h cathode capacity.
